(19) United States
(12) Patent Application Publication
(10) Pub. No.: US 2012/0303905 A1
(43) Pub. Date: Nov. 29, 2012

(54) METHOD AND APPARATUS FOR IMPLEMENTING CACHE

(76) Inventors: Wei ZHANG, Shenzhen (CN); Mingchang WEI, Shenzhen (CN); Zhixin CHEN, Shenzhen (CN)

(21) Appl. No.: 13/570,770

(22) Filed: Aug. 9, 2012

Related U.S. Application Data
(63) Continuation of application No. PCT/CN2011/070835, filed on Jan. 31, 2011.

(30) Foreign Application Priority Data
Feb. 10, 2010 (CN) 201010116496.0

(51) Int. Cl. G06F 12/12

(52) U.S. Cl. 711/136; 711/E12.071

(57) ABSTRACT

In embodiments of the present invention, a file access request sent by an application to a hard disk is obtained, file information of the accessed file is acquired according to the request, the file accessed by the application is fragmented to obtain at least one file fragment, a condition for copying the file fragment from the hard disk to the cache is set, and the file fragment is copied to the cache when the copying condition is met in a storage unit. Compared with a technical solution in the prior art where the file is copied to the cache, utilization efficiency of the cache is effectively improved.

### CROSS-REFERENCE TO RELATED APPLICATIONS

This application is a continuation of International Application No. PCT/CN2011/070835, filed on Jan. 31, 2011, which claims priority to Chinese Patent Application No. 201010116496.0, filed on Feb. 10, 2010, both of which are hereby incorporated by reference in their entireties.

### FIELD OF THE INVENTION

The present invention relates to a storage technology field, and in particular, to a method and an apparatus for implementing cache.

### BACKGROUND OF THE INVENTION

A cache (Cache) is a special memory sub-system. Frequently used data or a hotspot file is replicated in the cache to help reduce or eliminate an impact of a speed difference between a CPU and a memory on system performance. Taking that a solid state disk (Solid state disk, SSD) is used as the cache as an example, in the prior art, when an application accesses a particular file in the memory, the cache queries whether this file is stored, and if the file is stored, directly returns file data to the application. As data processing of the cache is always faster than that of the preceding memory, the cache formed by the SSD greatly increases a file access speed.

During implementation of the present invention, however, the inventor finds that: a read request obtained by a cache in the prior art includes only a start address and length of an accessed data block but not a mapping relationship between the data block and a file; the data block may correspond to several files, and not all of the several files corresponding to the data block are frequently accessed data or hotspot files; therefore, recognition accuracy of a hotspot file is reduced, and utilization efficiency of the cache is thereby reduced.

### SUMMARY OF THE INVENTION

Embodiments of the present invention provide a method and an apparatus for implementing cache so as to effectively improve utilization efficiency of a cache.

An embodiment of the present invention provides a method for implementing cache, which includes:

obtaining a file access request sent by an application to a hard disk, and acquiring file information of an accessed file according to the request;

fragmenting the file accessed by the application according to the obtained file information to obtain at least one file fragment; and

judging whether the obtained file fragment meets, within a preset time segment, a condition for copying it from the hard disk to a cache; if yes, copying the file fragment that meets the copying condition from the hard disk to the cache.

An embodiment of the present invention further provides a cache, which includes:

a file information acquiring unit, configured to obtain a file access request sent by an application to a hard disk, and acquire file information of an accessed file according to the request;

a file fragmenting unit, configured to fragment the file accessed by the application according to the obtained file information to obtain at least one file fragment; and

a storage processing unit, configured to judge whether the obtained file fragment meets, within a preset time segment, a condition for copying it from the hard disk to a cache; and if yes, copy the file fragment that meets the copying condition from the hard disk to the cache.

In the embodiments of the present invention, the file accessed by the application is fragmented to obtain a file fragment, the condition for copying the file fragment from the hard disk to the cache is set, and the file fragment is copied to the cache when the copying condition is met in a storage unit. Compared with a technical solution in the prior art where the file is copied to the cache, the utilization efficiency of the cache is effectively improved.

### BRIEF DESCRIPTION OF THE DRAWINGS

To better illustrate the technical solutions in the embodiments of the present invention or in the prior art, the accompanying drawings that need to be used in the embodiments are briefly described. Apparently, the accompanying drawings described below illustrate only some embodiments of the present invention, and those skilled in the art may obtain other accompanying drawings based on these accompanying drawings without creative efforts.

FIG. 1 is a flowchart of a method for implementing cache according to an embodiment of the present invention;

FIG. 2 is a flowchart of another method for implementing cache according to an embodiment of the present invention;

FIG. 3 is a flowchart of another method for implementing cache according to an embodiment of the present invention;

FIG. 4 is a block diagram of a structure of a cache according to an embodiment of the present invention; and

FIG. 5 is a block diagram of a structure of another cache according to an embodiment of the present invention.

### DETAILED DESCRIPTION OF THE EMBODIMENTS

To make the preceding purpose, features, and advantages of the present invention more explicit, the following describes the present invention in further detail with reference to the accompanying drawings and embodiments.

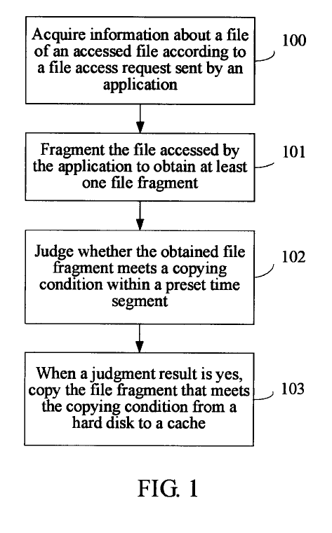

Referring to FIG. 1, an embodiment of the present invention provides a method for implementing cache, which includes the following steps:

Step 100: Obtain a file access request sent by an application to a hard disk, and acquire information about a file of an accessed file according to the request.

In the prior art, as the cache is located below a file system, the read request received by the cache includes only a start address and length of an accessed data block but not a mapping relationship between the data block and a file. In this embodiment of the present invention, a cache module is placed above the file system so that when the application accesses a particular file or directory, the cache may receive the access request of the application and acquire information about a file being accessed by the application, including a file name, a file path, a file size, and so on; in this way, the information about the file being accessed by the application may be known, including the file name, the file path, the file size, and so on.

Step 101: Fragment the file accessed by the application according to the obtained information about the file to obtain at least one file fragment.

For example, a size of file A is 100 MB. Assume that a file fragment size is 10 MB. In this case, the file is first logically divided into 10 fragments, where file fragment sizes corresponding to different file types may be preset. For example, a media file fragment may be 70 MB in size, and a small file such as a ringback tone file is not fragmented.

Step 102: Judge whether the obtained file fragment meets, within a preset time segment, a condition for copying it from the hard disk to a cache.

In this embodiment of the present invention, a hotspot file fragment that is frequently accessed in a file is copied to the cache. Determination and statistics collection of the hotspot file fragment have a particular relationship with time segments. For example, an access condition of video on demand in an on-duty time segment greatly differs from that in an off-duty time segment. An access condition of a video during a holiday also differs greatly from that in a common day. Therefore, during collecting statistics about an access frequency of the file fragment, a time segment for the statistics collection may be set according to an actual condition, for example, the specific statistics collection time, a statistics collection duration, and so on.

Step 103: If the judgment result is yes, copy the file fragment that meets the copying condition from the hard disk to the cache.

Where, as a function of a cache is to serve as a match to adjust a gap between devices with a large difference in transmission speed and reduce an impact of a speed difference between a CPU and a memory on system performance, the cache needs to use a hard disk whose read/write performance is higher than read/write performance of a hard disk that stores the file accessed by the application.

In the solution of the preceding embodiment, the file accessed by the application is fragmented to obtain a file fragment, the condition for copying the file fragment from the hard disk to the cache is set, and the file fragment is copied to the cache when the copying condition is met. Compared with a technical solution in the prior art where the file is copied to the cache, utilization efficiency of the cache is effectively improved.

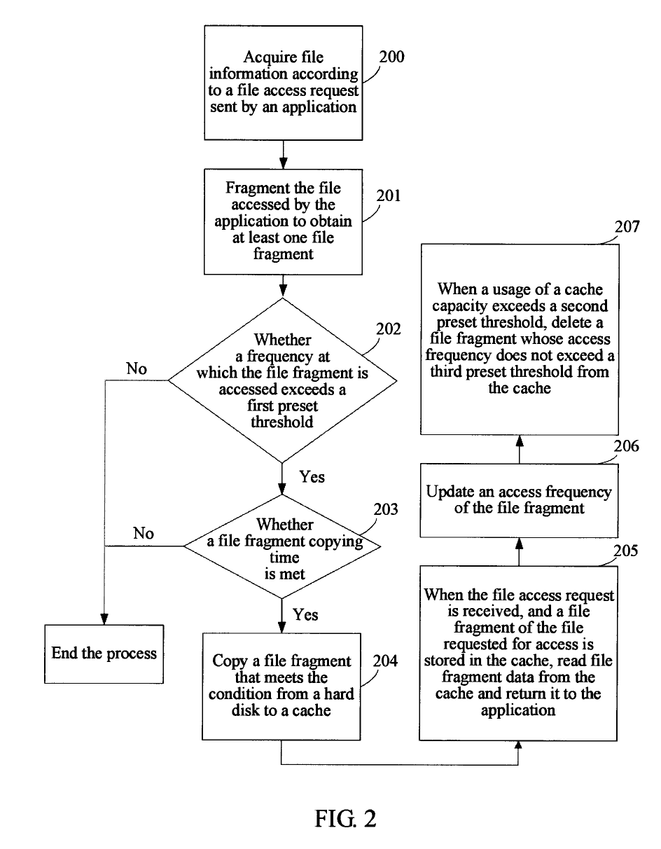

Referring to FIG. 2, an embodiment of the present invention further provides another method for implementing cache, which includes the following steps:

Step 200: Obtain a file access request sent by an application to a hard disk, and acquire information about a file of an accessed file according to the request.

In the prior art, as the cache is located below a file system, the read request received by the cache includes only a start address and length of an accessed data block but not a mapping relationship between the data block and a file. In this embodiment of the present invention, a cache module is placed above the file system so that when the application accesses a particular file or directory, the cache may receive the access request of the application and acquire information about a file being accessed by the application, including a file name, a file path, a file size, and so on; in this way, the information about the file being accessed by the application may be known, including the file name, the file path, the file size, and so on.

Step 201: Fragment the file accessed by the application according to the obtained information about the file to obtain at least one file fragment.

Where, file fragment sizes corresponding to different file types may be preset. For example, a media file fragment may be 70 MB in size, and a small file such as a ringback tone file is not fragmented.

Step 202: Judge whether a frequency at which the obtained file fragment is accessed within a preset time segment exceeds a first preset threshold; if yes, go to step 203; if no, end the process

Whether the file fragment is a hotspot file fragment is determined by judging whether the frequency at which the file fragment is accessed exceeds the first preset threshold. In this solution, to improve judgment efficiency, judgment on the hotspot file fragment may include:

judging whether a file type of the file accessed by the application is a hotspot file type; if yes, judging whether the frequency at which the obtained file fragment is accessed within the preset time segment exceeds the first preset threshold.

Where, hotspot file types may be preset, and whether the file accessed by the application is of a hotspot file type may be judged through a file name extension during processing. When the file is of the hotspot file type, a judgment is further made on whether the file fragment is a hotspot file fragment, thereby improving processing efficiency. For example, in a network television service, in addition to a media file type, some auxiliary file types are also included, and the cache may not process files belonging to these auxiliary file types.

Where, the determination and statistics collection of the hotspot file fragment have a particular relationship with time segments. For example, an access condition of video on demand in an on-duty time segment greatly differs from that in an off-duty time segment. An access condition of a video during a holiday also differs greatly from that in a common day. Therefore, during collecting statistics about an access frequency of the file fragment, a time segment for the statistics collection may be set according to an actual condition, for example, the specific statistics collection time, a statistics collection duration, and so on.

In addition, the frequency at which the file fragment is accessed within the preset time segment may also be obtained by setting times of statistics collection within the preset time segment and comprehensive analyzing an access frequency that is obtained from multiple times of statistics collection with the preset time segment; where, statistics obtained each time may undergo weighted average calculation to obtain the frequency at which the file fragment is accessed within the statistics collection time.

Where, a setting of the first preset threshold as the threshold of the frequency at which the hotspot file fragment is accessed is related to a file type, and different first preset thresholds corresponding to access frequencies may be set for different file types.

Step 203: Judge whether a preset time for copying the file fragment is met; if yes, go to step 204; if no, end the process.

Copying data in the hard disk to the cache needs to consume resources such as CPU, memory, and hard disk bandwidth. To minimize an impact of a new resource requirement introduced by copying on resources required by the current access, in a case where it is determined that the frequency at which the obtained file fragment is accessed within the preset time segment exceeds the first preset threshold, a judgment is made on whether the preset copying time is met, where, the preset copying time may include a case where a CPU usage, a hard disk usage, or a memory usage meets a preset condition.

Preferably, meeting the copying time may be the case where all system resource usage parameters such as the CPU usage, the hard disk usage, and the memory usage meet the preset conditions at the same time; where, a user may set values of the system resource usage parameters when the preset conditions are met, but the system may also provide an experience value respectively, for example, 80% for the hard disk usage;

It should be noted that step 203 is a preferred step, and step 204 may be directly performed when the judgment result in step 202 is yes.

Step 204: Copy the file fragment that meets the condition from the hard disk to the cache.

To further improve the utilization rate of the cache, preferably, this method may further include the following steps:

Step 205: When the access request of the application is obtained, judge whether a file fragment requested for access is stored in the cache; if yes, read file fragment data from the cache and return the file fragment data to the application.

Step 206: When the file fragment stored in the cache is accessed, update the access frequency of the file fragment.

Step 207: When a usage of the cache capacity exceeds a second preset threshold, delete a file fragment whose access frequency does not exceed a third preset threshold from the cache.

In the technical solution of the preceding embodiment, the file fragment accessed by the application is acquired, the judgment on the hotspot file fragment is made by judging the access frequency of the file fragment, and whether to copy the hotspot file fragment in a storage unit to the cache is determined by combining usage conditions of computer system resources. Compared with a technical solution in the prior art where the entire file is copied to the cache, utilization efficiency of the cache is effectively improved.

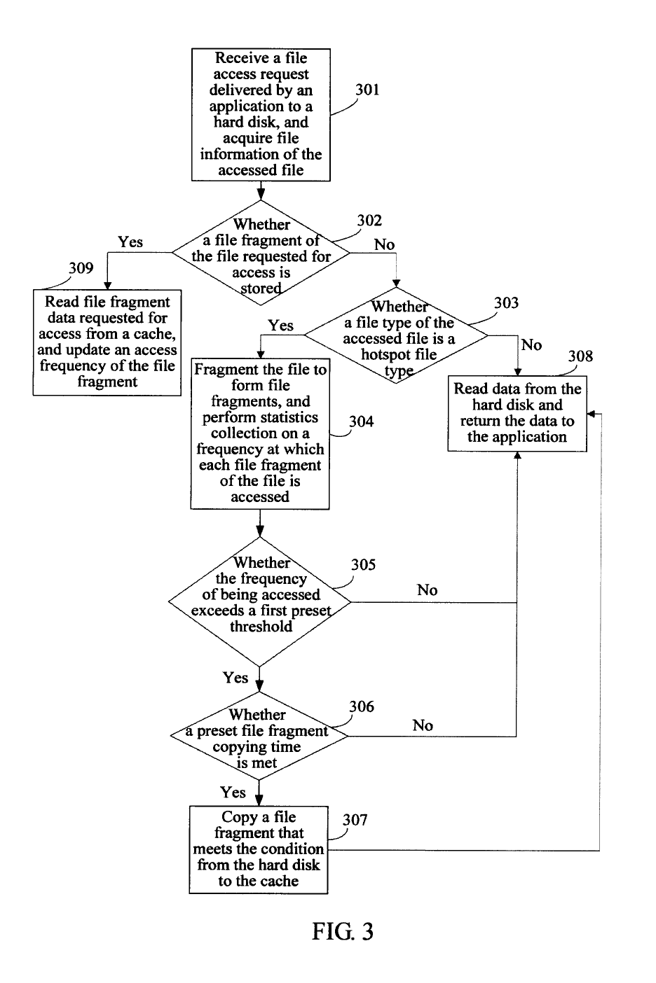

Referring to FIG. 3, by combining a specific application scenario, an embodiment of the present invention further provides a method for implementing cache, which includes the following steps:

Step 301: Receive a file access request delivered by an application to a hard disk, and acquire information about a file of an accessed file according to the request.

Step 302: Judge whether a file fragment of the file requested for access is stored in the cache; if yes, go to step 309; if no, go to step 303.

Step 303: Judge whether a file type of the accessed file is a hotspot file type; if yes, go to step 304; if no, go to step 308.

Where, hotspot file types may be preset. The hotspot file types may be types of files whose frequencies of being accessed are high, or an administrator may set the hotspot file types according to a specific requirement. Whether a file fragment that needs to be accessed is of a hotspot file type may be judged through a file name extension. For example, in a network television service, in addition to a media file type, some auxiliary file types are also included, and the cache may not process files belonging to these auxiliary file types so as to improve processing efficiency.

Step 304: Fragment the file to form file fragments, and perform statistics collection on a frequency at which each file fragment of the file is accessed.

Where, in this embodiment of the present invention, a cache module is placed above a file system. Therefore, when the application accesses a particular file or directory, the cache may know file information of a file being accessed by the application, including a file name, a file path, a file size, and so on.

Step 305: Judge whether the frequency at which each file fragment is accessed exceeds a first preset threshold; if yes, go to step 306; if no, go to step 308.

Where, a setting of the first preset threshold is related to a file type, and different first preset thresholds corresponding to access frequencies may be set for different file types.

Step 306: Judge whether a preset time for copying a file fragment is met; if yes, go to step 307; if no, go to step 308.

Where, the preset copying time may include a case where a CPU usage, a hard disk usage, a memory usage, or another system resource usage parameter meets a preset condition; preferably, meeting the copying time may be the case where all system resource usage parameters such as the CPU usage, the hard disk usage, and the memory usage meet preset conditions at the same time; where, a user may set values of the system resource usage parameters when the preset conditions are met, but a system may also provide an experience value respectively. For example, in an IP video on demand service system, when 1200 concurrent streams of access are supported, the system is already busy. Assume that the current CPU usage already reaches 90%. In this case, if a hotspot file fragment is copied from the hard disk to the cache, the CPU usage may probably further increase, which may cause that the system fails to handle the 1200 concurrent streams of access during the copying process. Therefore, to minimize an impact of a new resource requirement introduced by copying on resources required by the current access, in a case where it is determined that a frequency at which an obtained file fragment is accessed within a preset time segment exceeds the first preset threshold, preferably, the copying time is further considered.

Step 307: Copy a file fragment that meets the condition from the hard disk to the cache.

Where, the cache may be formed by a solid state disk and be set with multiple different interfaces, for example, a traditional interface and a peripheral component interconnection-express (Peripheral Component Interconnect-Express, PCIE) interface. According to different features of the interfaces, different copying policies may be selected for copying the file fragment to the cache. For example, in a large input/output application, such as video processing, the PCIE interface may be selected for copying a video file fragment to the cache.

Where, the cache includes a storage medium formed by a solid state disk.

Step 308: Read data from the hard disk and return the data to the application, and end the process.

Step 309: Read file fragment data requested for access from the cache, return the file fragment data to the application, and update an access frequency of the file fragment.

In this embodiment of the present invention, the file accessed by the application is fragmented to obtain a file fragment, the condition for copying the file fragment from the hard disk to the cache is set, and the file fragment is copied to the cache when the copying condition is met in a storage unit. Compared with a technical solution in the prior art where the file is copied to the cache, utilization efficiency of the cache is effectively improved.

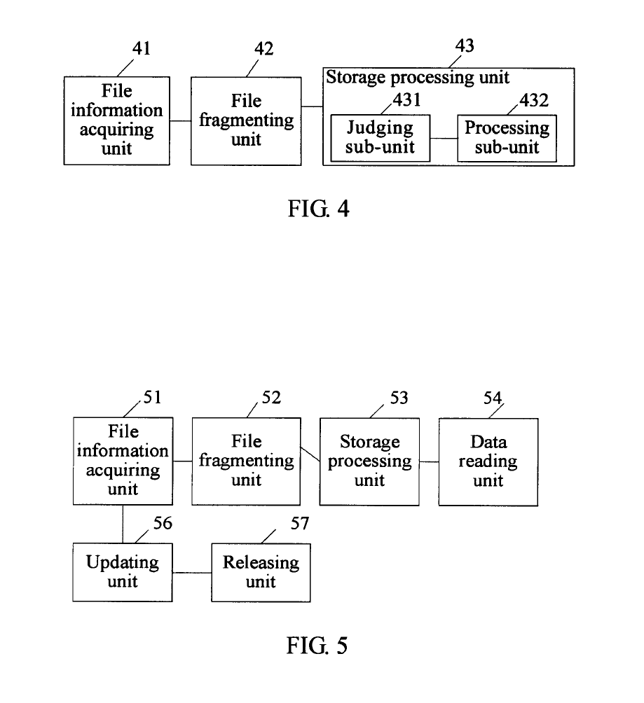

Referring to FIG. 4, an embodiment of the present invention provides a cache, which includes:

a file information acquiring unit 41, configured to obtain a file access request sent by an application to a hard disk, and acquire information about a file of an accessed file according to the request;

where, in this embodiment of the present invention, a cache module is placed above a file system. Therefore, when the application accesses a particular file or directory, the cache may receive the access request of the application, and acquire information about a file being accessed by the application, including a file name, a file path, a file size, and so on;

a file fragmenting unit 42, configured to fragment the file accessed by the application according to the obtained information about the file to obtain at least one file fragment;

where, file fragment sizes corresponding to different file types may be preset; and

a storage processing unit 43, configured to judge whether the obtained file fragment meets, within a preset time segment, a condition for copying it from the hard disk to a cache; if yes, copy the file fragment that meets the copying condition from the hard disk to the cache;

where, as a function of a cache is to serve as a match to adjust a gap between devices with a large difference in transmission speed and reduce an impact of a speed difference between a CPU and a memory on system performance, the cache needs to use a hard disk whose read/write performance is higher than read/write performance of a hard disk that stores the file accessed by the application.

In the solution of the preceding embodiment, the cache fragments the file accessed by the application to obtain a file fragment, and judges whether the file fragment is a hotspot file fragment, thereby effectively improving the utilization efficiency of the cache.

In the preceding embodiment, preferably, the storage processing unit 43 may include:

a judging sub-unit 431, configured to judge whether a frequency at which the obtained file fragment is accessed within the preset time segment exceeds a first preset threshold, or judge whether the frequency at which the obtained file fragment is accessed within the preset time segment exceeds the first preset threshold and whether a copying time preset according to a system resource usage condition is met;

where, a setting of the first preset threshold as a threshold of the frequency at which the hotspot file fragment is accessed is related to a file type, and different first preset thresholds corresponding to access frequencies may be set for different file types;

where, to improve processing efficiency, the cache may process only a file of a hotspot file type. Therefore, preferably, the judging sub-unit 431 is specifically configured to: judge whether a file type of the file accessed by the application is a hotspot file type, and if yes, judge whether the frequency at which the obtained file fragment is accessed within the preset time segment exceeds the first preset threshold or judge whether the frequency at which the obtained file fragment is accessed within the preset time segment exceeds the first preset threshold and whether the copying time preset according to the system resource usage condition is met;

where, hotspot file types may be preset. When a file is of a hotspot file type, a judgment is further made on whether the file fragment is a hotspot file fragment, thereby improving the processing efficiency; and

a processing sub-unit 432, configured to copy a file fragment that meets the copying condition from the hard disk to the cache when a judgment result of the judging sub-unit is yes.

Referring to FIG. 5, an embodiment of the present invention further provides a cache, which includes:

a file information acquiring unit 51, configured to obtain a file access request sent by an application to a hard disk, and acquire information about a file of an accessed file according to the request;

where, in this embodiment of the present invention, a cache module is placed above a file system. Therefore, when the application accesses a particular file or directory, the cache may receive the access request of the application, and acquire information about a file being accessed by the application, including a file name, a file path, a file size, and so on;

a file fragmenting unit 52, configured to fragment the file accessed by the application according to the obtained information about the file to obtain at least one file fragment;

where, file fragment sizes corresponding to different file types may be preset;

a storage processing unit 53, configured to judge whether the obtained file fragment meets, within a preset time segment, a condition for copying it from the hard disk to a cache; if yes, copy the file fragment that meets the copying condition from the hard disk to the cache; and

a data reading unit 54, configured to, when the access request of the application is obtained, judge whether a file fragment of the file requested for access is stored in the cache; if yes, read the file fragment data requested for access from the cache and return the file fragment data to the application.

In this embodiment, a data reading unit is added. When a file access request is received, if the file fragment of the file is already stored in the cache, the file fragment is directly read from the cache and returned to the application. The cache reads faster than the hard disk. Therefore, data read efficiency is effectively improved.

A read/write speed of a cache is higher than that of a common memory. Therefore, the cost of a cache is high. To effectively use the storage space in the cache, preferably, the cache further includes:

an updating unit 55, configured to, when the file fragment stored in the cache is accessed, update an access frequency of the file fragment; and

a releasing unit 56, configured to, when a usage of a cache capacity exceeds a second preset threshold, delete a file fragment whose access frequency does not exceed a third preset threshold from the cache.

In the solution of the preceding embodiment, the file fragment accessed by the application is acquired, the judgment on the hotspot file fragment is made by judging the access frequency of the file fragment, and whether to copy the hotspot file fragment in a storage unit to the cache is determined by combining usage conditions of computer system resources. Compared with a technical solution in the prior art where the entire file is copied to the cache, utilization efficiency of the cache is effectively improved.

Through descriptions in the preceding embodiments, those skilled in the art may clearly understand that the present invention may be implemented through software by combining a necessary hardware platform, or entirely through hardware. In most cases, however, the former is a preferred implementation manner. The technical solutions in the present invention may be essentially or the part that contributes to the prior art may be embodied in the form of a software product. This computer software product may be stored in a storage medium, such as ROM/RAM, a disk tape, and a CD-ROM, and includes several instructions that are configured for a computer device (which may be, for example, a personal computer, a server, or a network device) to execute the methods described in each of the embodiments of the present invention or some parts of the embodiments.

The present invention is described in the preceding embodiments. Several examples are used for illustration of the principles and implementation manners of the present invention. The description of these examples is used to help illustrate the methods and core ideas of the present invention. Those skilled in the art can make modifications to the specific implementation manners and application scopes according to the ideas of the present invention. To sum up, content of this specification shall not be construed as a limitation on the present invention.

What is claimed is:

1. A method for implementing cache, comprising:
obtaining a file access request sent by an application to a hard disk, and acquiring information about a file of an accessed file according to the request;
fragmenting the file accessed by the application according to the obtained information about the file to obtain at least one file fragment; and
judging whether the obtained file fragment meets, within a preset time segment, a condition for copying it from the hard disk to a cache; if yes, copying the file fragment that meets the copying condition from the hard disk to the cache.

2. The method for implementing cache according to claim 1, wherein, the judging whether the obtained file fragment meets, within a preset time segment, the condition for copying it from the hard disk to the cache comprises:
judging whether a frequency at which the obtained file fragment is accessed within the preset time segment exceeds a first preset threshold;
or
judging whether a frequency at which the obtained file fragment is accessed within the preset time segment exceeds a first preset threshold and whether a copying time preset according to a system resource usage condition is met.

3. The method for implementing cache according to claim 2, further comprising:
when obtaining the file access request of the application, judging whether a file fragment of a file requested for access is stored in the cache; if yes, reading file fragment data requested for access from the cache and returning the file fragment data to the application.

4. The method for implementing cache according to claim 2, wherein, the judging whether the frequency at which the obtained file fragment is accessed within the preset time segment exceeds the first preset threshold comprises:
judging a file type of the file accessed by the application according to the file information, and when it is judged that the obtained file type is a preset hotspot file type, judging whether a frequency at which each file fragment of the obtained file is accessed within the preset time segment exceeds the first preset threshold.

5. The method for implementing cache according to claim 1, further comprising:
when a file fragment stored in the cache is accessed, updating an access frequency of the file fragment; and
when a usage of a cache capacity exceeds a second preset threshold, deleting a file fragment whose access frequency does not exceed a third preset threshold from the cache.

6. The method for implementing cache according to claim 1, wherein, different first preset thresholds are set for different file types, and a file fragment size is determined according to different file types.

7. The method for implementing cache according to claim 1, wherein, the file information of the accessed file comprises: a file name, a file path, and a file size.

8. A cache, wherein, the cache is placed above a file system and comprises:
a file information acquiring unit, configured to obtain a file access request sent by an application to a hard disk, and acquire information about a file of an accessed file according to the request;
a file fragmenting unit, configured to fragment the file accessed by the application according to the obtained information about the file to obtain at least one file fragment; and
a storage processing unit, configured to judge whether the obtained file fragment meets, within a preset time segment, a condition for copying it from the hard disk to a cache; if yes, copy the file fragment that meets the copying condition from the hard disk to the cache.

9. The cache according to claim 8, wherein the storage processing unit comprises:
a judging sub-unit, configured to judge whether a frequency at which the obtained file fragment is accessed within the preset time segment exceeds a first preset threshold, or judge whether the frequency at which the obtained file fragment is accessed within the preset time segment exceeds the first preset threshold and whether a copying time preset according to a system resource usage condition is met; and
a processing sub-unit, configured to copy the file fragment that meets the copying condition from the hard disk to the cache when a judgment result of the judging sub-unit is yes.

10. The cache according to claim 8, further comprising:
an updating unit, configured to, when a file fragment stored in the cache is accessed, update an access frequency of the file fragment; and
a releasing unit, configured to, when a usage of a cache capacity exceeds a second preset threshold, delete a file fragment whose access frequency does not exceed a third preset threshold from the cache.

11. The cache according to claim 8, wherein the judging sub-unit is specifically configured to:
judge whether a file type of the file accessed by the application is a hotspot file type; if yes, judge whether the frequency at which the obtained file fragment is accessed within the preset time segment exceeds the first preset threshold or judge whether the frequency at which the obtained file fragment is accessed within the preset time segment exceeds the first preset threshold and whether the copying time preset according to the system resource usage condition is met.

12. The cache according to claim 8, wherein, the cache is set with multiple different interfaces and according to different features of the interfaces, different copying policies may be selected, according to different interfaces, for copying the file fragment to the cache.
